(19) United States
(12) Patent Application Publication
(10) Pub. No.: US 2005/0044379 A1
(43) Pub. Date: Feb. 24, 2005

(54) Blind exchange of keys using an open protocol

(75) Inventors: Jonathan D. Beard, Tucson, AZ (US); Craig F. Schultz, Tucson, AZ (US); Douglas W. Todd, Tucson, AZ (US)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, ARMONK, NY (US)

(21) Appl. No.: 10/644,515

(22) Filed: Aug. 20, 2003

(51) Int. Cl. H04L 9/32

(52) U.S. Cl. 713/182

(57) ABSTRACT

A computer system and method where a user is authenticated to both an authentication server and to a client machine, but no link between the client machine and authentication server is needed. Login information is provided from the client machine to the technician machine in an encrypted format using a public key so that the technician machine cannot access the login information. The technician machine communicates the encrypted login information to an authentication server, which decrypts the login information using a private key and provides the decrypted login information to the technician machine if the technician machine can authenticate itself to the authentication server. The invention is particularly useful in enabling field service technicians to access client computer systems from remote locations such as field offices, hotel rooms, airports and the like.

### BACKGROUND OF THE INVENTION

1. Field of Invention

The invention relates generally to the field of encryption and, more specifically, to a system and method for authorizing a user to access a client machine.

2. Description of Related Art

Field service technicians often need to perform maintenance and other work on client computer equipment such as servers in a data insecure environment. Often times, the technician will be located in a data insecure environment such as a hotel room, airport, field office, or the like, and will connect to the customer machine via a dial up telephone connection to diagnose and fix problems. Since data security is important to many customers, it is necessary to ensure that the technician is authorized to perform the maintenance. Conventionally, this can be achieved by the client machine connecting to an authentication server, such as one provided by the technician's employer, to verify authentication information provided by the technician. However, some client machines are on closed networks that do not connect to the outside world or otherwise may not want to establish such connections to avoid the possibility of eavesdropping. Examples of such machines include servers used by the government to store sensitive information.

Accordingly, there is a need for a technique to authenticate a user's access to a client machine when the client machine cannot independently authenticate the user.

### BRIEF SUMMARY OF THE INVENTION

To address the above and other issues, the present invention describes a technique for authenticating access to a client machine.

In a particular aspect of the invention, a method for authenticating a user's access to a client machine includes communicating a request for access from the user machine to the client machine, establishing a login account with login information at the client machine in response to the request, encrypting the login information at the client machine and communicating the encrypted login information to the user machine, communicating the encrypted login information and authentication information associated with the user from the user machine to an authentication server, and decrypting the encrypted login information at the authentication server and communicating the decrypted login information to the user machine if the authentication information is acceptable to the authentication server.

Related methods are provided for the user machine and the client machine.

Corresponding systems and program storage devices are also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates establishing a logon account at a client machine for a technician machine;

FIG. 2 illustrates authenticating a technician at an authentication server; and

FIG. 3 illustrates a technician machine logging in to the client machine.

### DETAILED DESCRIPTION OF THE INVENTION

The present invention describes a technique for authenticating access to a client machine.

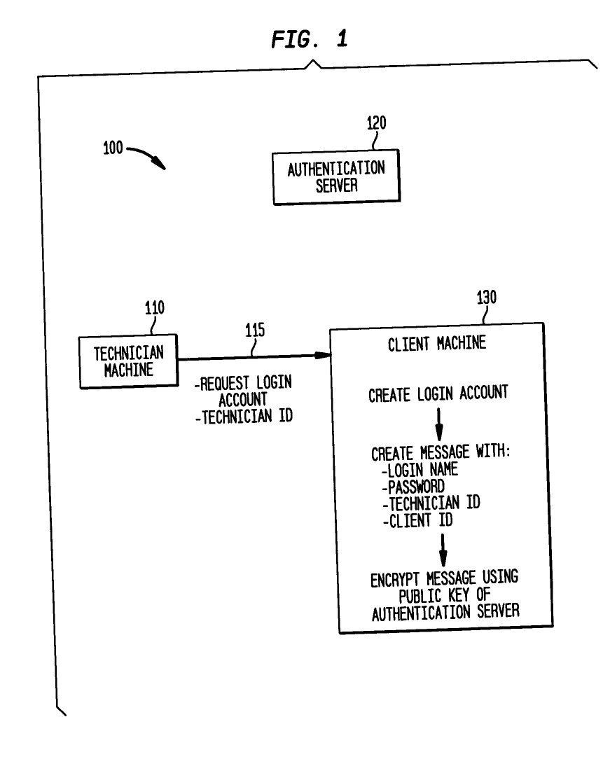

FIG. 1 illustrates establishing a logon account at a client machine for a technician machine. A computer system 100 includes a computer machine 110, such as a laptop computer, of a technician or other user. For example, the technician may be an employee of a company that provides computer maintenance services for a number of client machines, such as the computers and network equipment of another company, university, government agency or other organization. The technician machine 110 needs to access the client machine 130 to provide maintenance to troubleshoot problems and perform routine maintenance or other services. The client machine 130 may be a server, for example, that allows the technician machine 110 to access a number of computers and network equipment such as routers and the like within the organization of the client machine 130. In particularly secure environments, such as those used by government agencies that store sensitive information, the client machine 130 must be able to reliably authenticate the technician machine 110, e.g., to ensure that the technician machine 110 and the associated user is authorized to access the client machine 130.

To access the client machine 130, the technician machine 110 contacts the client machine 130 via a communication path 115. For example, the communication path 115 may be a secure Internet connection using the Secure Sockets Layer (SSL) protocol. The technician machine 110 may run web browser software such as Netscape or Internet Explorer. A script is invoked at the client machine 130 to create a login account for the technician machine 110. The login account includes login information such as a login name and a password, which may be randomly generated. In one example implementation, the client machine 130 includes a server using open-source Apache web hosting software for web hosting, mod_ssl for secure sockets and mod_perl for login ID generation. Mod_ssl is the Apache interface to OpenSSL, an open source toolkit implementing SSL. Mod_perl brings together the Perl programming language and the Apache HTTP server. The technician machine 110 may also communicate an identifier associated with the technician using the machine 110. The identifier can be an employee number, the technician's name, and/or social security number or the like. The technician may type in the identifier on a keyboard of the technician machine 110 to have it communicated to the client machine 130, for example.

The client machine 130 may also run software such as Gnu Privacy Guard (GPG) or Pretty Good Privacy (PGP) for encrypting and decrypting keys, as well as running OpenSSH for providing a secure session to the technician machine 110 when the technician machine 110 subsequently logs in. OpenSSH, developed primarily by the OpenBSD Project, is an open source version of the SSH Secure Shell protocol suite of network connectivity tools from SSH Communication Security, Inc., that encrypts all traffic (including passwords) to effectively eliminate eavesdropping, connection hijacking, and other network-level attacks for user telnet, rlogin, ftp, and other such programs. The client machine 130 uses encryption software such as GPG to provide an encrypted, formatted message that includes the login information, such as login name and password, along with the technician's identifier (ID). The encrypted massage may also include an identifier associated with the client. The client identifier (client ID) may identify the client, e.g., organization A, or the particular client machine 130, e.g., by serial number. In one possible approach, the client machine 130 encapsulates the login information, technician ID and client ID, in an XML message that is encrypted using GPG. GPG is a type of public key encryption that uses a freely available public key that is part of a public-key-private key pair. A message encrypted using a particular public key can only be decrypted using the associated private key of the pair.

In a specific implementation, the client machine 130 uses the public key of the authentication server 120. The client machine 130 may be pre-loaded with the public key or keys of the one or more organizations that it has authorized to perform maintenance on its computer systems. Such public keys may be obtained from a source such as a web site that is a repository for public keys or otherwise made available to the client machine 130. After encrypting the message using the public key, e.g., by GPG or PGP, the client machine 130 communicates the encrypted message to the technician machine 110 via the communication path 115 using the established link such as the SSL connection.

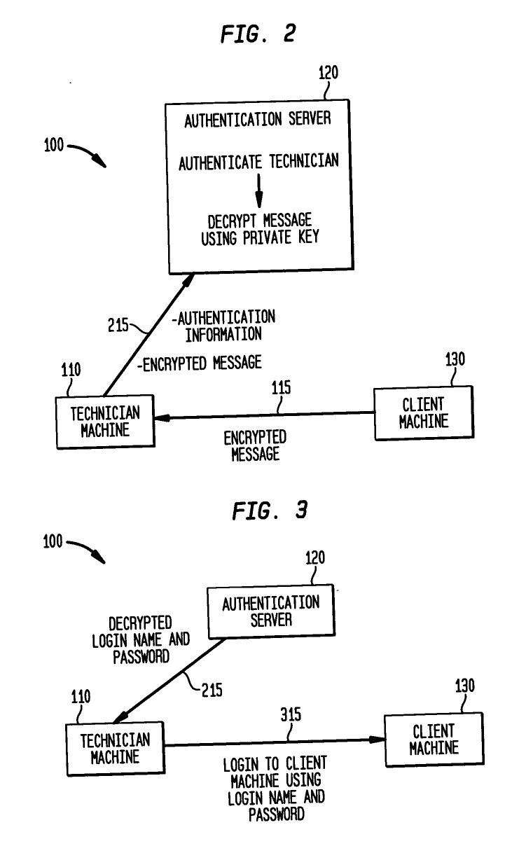

FIG. 2 illustrates authenticating a technician at an authentication server. When the technician machine 110 receives the encrypted message from the client machine 130, it establishes a connection with, and provides the encrypted message to, an authentication server 120 via a communication path 215. For example, the encrypted message may be made available to the technician machine 110 via a web page of the client machine 130. In this case, the technician may copy the encrypted message as a block of data from the returned web page and paste the data into a form provided by a web site of the authentication server 120. The communication path 215 may use a secure connection such as an Internet connection using the SSL protocol. The authentication server 120, which may be hosted by the technician's employer, authenticates the technician's identity. To this end, the technician machine 110 communicates authentication information to the authentication server 120. The authentication information may include an identifier associated with the user such as an employee name or number, social security number, and/or password or the like.

The authentication server 120 determines whether the authentication information provided by the technician machine 110 is acceptable, e.g., whether the employee identifier and password correspond with previously established information. If it is not acceptable, an appropriate message is provided to the technician. If the authentication information is acceptable, the encrypted message is decrypted using the private key of the GPG or PGP public-key-private key pair to recover the login information of the client machine, the technician identifier, and the client identifier. Additional authentication checks may be made to ensure that the technician identifier corresponds with the identifier provided in the authentication information. Additionally, it may be determined whether the particular technician is authorized to access the particular client machine based on the client identifier. For example, technician A may be only authorized to access the computer systems of client A. If the client identifier refers to a client B, then technician A is not authorized. If the client identifier refers to client AB, then technician A is authorized. Thus, the encrypted message may be decrypted to provide information for use in the authentication process.

Once the technician has been authorized by the authentication server 110, the decrypted information is communicated to the technician machine 110 via the communicate path 215 using the established secure connection. The decrypted information is encrypted, e.g., under the SSL protocol and can be decrypted by the technician machine 110. In contrast, the technician machine 110 cannot decrypt the message encrypted by the client machine 130 since the technician machine does not have access to the private key used by the authentication server 120.

The software run by the authentication server 120 may include Apache web hosting software, mod_ssl for secure sockets, mod_perl for ID lookup, and GPG for decrypting the encrypted authentication information provided by the technician machine 110. The authentication server 120 may implement a database using known techniques to track the authorization status of different technicians, to distribute a current certificate for the equipment, and to distribute the public key. The authentication server 120 may provide a secure web page and certificate for access to it for each computer product needing servicing. Only the technicians needing to service particular computer equipment are given the certificate for the associated secure web page.

FIG. 3 illustrates a technician machine logging in to the client machine. The technician machine 110 receives the decrypted login information such as login name and password from the authentication server 120 via the communication path 215 and uses the login information to log in to the client machine. For example, the technician machine 110 may run OpenSSH client software to establish a secure connection, such as a telephone dial up connection, with the client machine 130 via the communication path 315. Since the technician machine 110 now has access to the login information of the client machine 130, it can log in to the client machine 130 and perform the necessary maintenance. The technician may remotely administer the client machine 130 using appropriate telnet or other software. Note that a time limit on the access may be imposed by the client machine 130, e.g., so that the technician has only 24 hours to perform the maintenance on the client machine 130 before a new authorization is required. Moreover, the public-private key pair may be changed periodically.

Accordingly, it can be seen that the present invention provides a computer system and method wherein a user is authenticated to both an authentication server and to a client machine, but no link between the client machine and authentication server is needed. Login information is provided from the client machine to the technician machine in an encrypted format that cannot be accessed by the technician machine. The technician machine communicates the encrypted login information to an authentication server, which decrypts the login information and provides it to the technician machine if the technician machine can authenticate itself to the authentication server. The invention is particularly useful in enabling field service technicians to access client computer systems from remote locations such as field offices, hotel rooms, airports and the like. However, other uses are possible. Moreover, open protocols may be used if desired, although proprietary protocols may be used as well.

Any known computer and communications hardware, software and/or firmware may be used to provide the functionality described herein. For example, a computer machine such as a laptop computer or server has known components such as a microprocessor, memory, network interface card, peripherals and the like, for communicating data, whether transmitting or receiving, and encrypting or decrypting data. The memory may comprise a program storage device for storing instructions such as software that, when executed by the microprocessor, achieve the functionality described herein, including communicating data, encrypting and decrypting data, establishing a login account, and so forth. These techniques and components as such are well-known in the art.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A method for authenticating a user's access to a client machine, comprising:
communicating a request for access from the user machine to the client machine;
establishing a login account with login information at the client machine in response to the request;
encrypting the login information at the client machine and communicating the encrypted login information to the user machine;
communicating the encrypted login information and authentication information associated with the user from the user machine to an authentication server; and
decrypting the encrypted login information at the authentication server and communicating the decrypted login information to the user machine if the authentication information is acceptable to the authentication server.

2. The method of claim 1, further comprising:
communicating an identifier associated with the user from the user machine to the client machine;
encrypting the identifier at the client machine and communicating the encrypted identifier to the user machine;
communicating the encrypted identifier from the user machine to the authentication server; and
decrypting the encrypted identifier at the authentication server;
wherein the decrypted login information is communicated to the user machine if the decrypted identifier is acceptable to the authentication server.

3. The method of claim 1, further comprising:
encrypting an identifier associated with the client machine at the client machine and communicating the encrypted identifier to the user machine;
communicating the encrypted identifier from the user machine to the authentication server; and
decrypting the encrypted identifier at the authentication server;
wherein the decrypted login information is communicated to the user machine if the decrypted identifier is acceptable to the authentication server.

4. The method of claim 1, further comprising:
communicating the login information from the user machine to the client machine to enable the user machine to access the client machine.

5. The method of claim 1, wherein:
the login information comprises at least one of a name and password.

6. The method of claim 1, wherein:
the login information is encrypted at the client machine using a public key of a public key-private key pair; and
the encrypted login information is decrypted at the authentication server using the private key of the public key-private key pair.

7. The method of claim 1, wherein:
the authentication information comprises an identifier associated with the user.

8. The method of claim 1, wherein:
the encrypted login information is inaccessible to the user machine.

9. The method of claim 1, wherein:
the request for access is communicated from the user machine to the client machine, and the encrypted login information is communicated from the client machine to the user machine via a Secure Sockets Layer connection.

10. A system for authenticating a user's access to a client machine, comprising:
means for communicating a request for access from the user machine to the client machine;
means for establishing a login account with login information at the client machine in response to the request;
means for encrypting the login information at the client machine and communicating the encrypted login information to the user machine;
means for communicating the encrypted login information and authentication information associated with the user from the user machine to an authentication server; and
means for decrypting the encrypted login information at the authentication server and communicating the decrypted login information to the user machine if the authentication information is acceptable to the authentication server.

11. A program storage device, tangibly embodying a program of instructions executable by a machine to perform a method for authenticating a user's access to a client machine, the method comprising:
communicating a request for access from the user machine to the client machine;
establishing a login account with login information at the client machine in response to the request;
encrypting the login information at the client machine and communicating the encrypted login information to the user machine;
communicating the encrypted login information and authentication information associated with the user from the user machine to an authentication server; and
decrypting the encrypted login information at the authentication server and communicating the decrypted login information to the user machine if the authentication information is acceptable to the authentication server.

12. A method for use at a user machine in authenticating a user's access to a client machine, comprising:
communicating a request for access from the user machine to the client machine;
receiving encrypted login information from the client machine that was generated in response to the request for access;
communicating the encrypted login information and authentication information associated with the user from the user machine to an authentication server; and
receiving decrypted login information from the authentication server that was derived by decrypting the encrypted login information when the authentication information is acceptable to the authentication server.

13. The method of claim 12, further comprising:
communicating an identifier associated with the user from the user machine to the client machine;
wherein the client machine encrypts the identifier and communicates the encrypted identifier to the user machine; and
communicating the encrypted identifier from the user machine to the authentication server;
wherein the authentication server decrypts the encrypted identifier and communicates the decrypted login information to the user machine if the decrypted identifier is acceptable to the authentication server.

14. The method of claim 12, wherein the client machine encrypts an associated identifier and communicates the encrypted identifier to the user machine, the method further comprising;
communicating the encrypted identifier from the user machine to the authentication server;
wherein the authentication server decrypts the encrypted identifier and communicates the decrypted login information to the user machine if the decrypted identifier is acceptable to the authentication server.

15. The method of claim 12, further comprising:
communicating the login information from the user machine to the client machine to enable the user machine to access the client machine.

16. The method of claim 12, wherein:
the login information comprises at least one of a name and password.

17. The method of claim 12, wherein:
the login information is encrypted at the client machine using a public key of a public key-private key pair; and
the encrypted login information is decrypted at the authentication server using the private key of the public key-private key pair.

18. The method of claim 12, wherein:
the authentication information comprises an identifier associated with the user.

19. The method of claim 12, wherein:
the encrypted login information is inaccessible to the user machine.

20. A program storage device, tangibly embodying a program of instructions executable by a user machine to perform a method for authenticating a user's access to a client machine, the method comprising:
communicating a request for access from the user machine to the client machine;
receiving encrypted login information from the client machine that was generated in response to the request for access;
communicating the encrypted login information and authentication information associated with the user from the user machine to an authentication server; and
receiving decrypted login information from the authentication server that was derived by decrypting the encrypted login information when the authentication information is acceptable to the authentication server.

21. A user machine for use in accessing a client machine, comprising:
means for communicating a request for access from the user machine to the client machine;
means for receiving encrypted login information from the client machine that was generated in response to the request for access;
means for communicating the encrypted login information and authentication information associated with the user from the user machine to an authentication server; and
means for receiving decrypted login information from the authentication server that was derived by decrypting the encrypted login information when the authentication information is acceptable to the authentication server.

22. The user machine of claim 21, further comprising:
means for communicating an identifier associated with the user from the user machine to the client machine;
wherein the client machine encrypts the identifier and communicates the encrypted identifier to the user machine; and
means for communicating the encrypted identifier from the user machine to the authentication server;
wherein the authentication server decrypts the encrypted identifier and communicates the decrypted login information to the user machine if the decrypted identifier is acceptable to the authentication server.

23. The user machine of claim 21, wherein the client machine encrypts an associated identifier and communicates the encrypted identifier to the user machine, the user machine further comprising;
means for communicating the encrypted identifier from the user machine to the authentication server;
wherein the authentication server decrypts the encrypted identifier and communicates the decrypted login information to the user machine if the decrypted identifier is acceptable to the authentication server.

24. The user machine of claim 21, further comprising:
means for communicating the login information from the user machine to the client machine to enable the user machine to access the client machine.

25. The user machine of claim 21, wherein:
the login information comprises at least one of a name and password.

26. The user machine of claim 21, wherein:
the login information is encrypted at the client machine using a public key of a public key-private key pair; and
the encrypted login information is decrypted at the authentication server using the private key of the public key-private key pair.

27. The user machine of claim 21, wherein:
the authentication information comprises an identifier associated with the user.

28. A method for use at a client machine for authenticating a user's access to the client machine, comprising:
receiving a request for access from the user machine at the client machine;
establishing a login account with login information at the client machine in response to the request;
encrypting the login information at the client machine and communicating the encrypted login information to the user machine;
wherein the user machine communicates the encrypted login information and authentication information associated with the user from the user machine to an authentication server, and the authentication server decrypts the encrypted login information and communicates the decrypted login information to the user machine if the authentication information is acceptable to the authentication server; and
receiving the login information from the user machine at the client machine to enable the user machine to access the client machine.

29. A program storage device, tangibly embodying a program of instructions executable by a client machine to perform a method for use at the client machine in authenticating a user's access to the client machine, the method comprising:
receiving a request for access from the user machine at the client machine;
establishing a login account with login information at the client machine in response to the request;
encrypting the login information at the client machine and communicating the encrypted login information to the user machine;
wherein the user machine communicates the encrypted login information and authentication information associated with the user from the user machine to an authentication server, and the authentication server decrypts the encrypted login information and communicates the decrypted login information to the user machine if the authentication information is acceptable to the authentication server; and
receiving the login information from the user machine at the client machine to enable the user machine to access the client machine.

30. A client machine in which a user's access to the client machine is authenticated, comprising:
means for receiving a request for access from the user machine at the client machine;
means for establishing a login account with login information at the client machine in response to the request;
means for encrypting the login information at the client machine and communicating the encrypted login information to the user machine;
wherein the user machine communicates the encrypted login information and authentication information associated with the user from the user machine to an authentication server, and the authentication server decrypts the encrypted login information and communicates the decrypted login information to the user machine if the authentication information is acceptable to the authentication server; and
means for receiving the login information from the user machine at the client machine to enable the user machine to access the client machine.
